(19) United States
(12) Patent Application Publication
(10) Pub. No.: US 2004/0187279 A1
(43) Pub. Date: Sep. 30, 2004

(54) Face protector for preventing undesired deformations to a deceased's face

(76) Inventors: Theresa Ann Christiansen, Whitesboro, NY (US); David John Schroeder, Whitesboro, NY (US)

Correspondence Address: David Giglio, 231 Elizabeth Street, Utica, NY, 13501, US

(21) Appl. No.: 10/402,406

(22) Filed: Mar. 31, 2003

(51) Int. Cl. A01N 1/00

(52) U.S. Cl. 27/21.1

(57) ABSTRACT

There is provided a method and apparatus for preventing a deceased from incurring undesirable facial deformations between the time of death and the time for embalmment. A face protector fits conveniently in a shroud kit and includes support structures and a top member. The top member is superpositioned over the deceased's face, such that a sheet placed over the deceased's face does not come into contact with the face. Therefore, undesirable facial deformations caused by the weight of the sheet are prevented.

### FIELD OF THE INVENTION

The present invention is generally related to the field of embalmment and, more particularly, to a method and apparatus for preventing deformations to the nose or face of a deceased's face prior to embalmment.

### BACKGROUND OF THE INVENTION

People pass away most often in hospitals, nursing homes, and other types of medical treatment or old age facilities. Often times the deceased is presented in a casket for viewing and grieving.

At the hospital or other facility where the person passes away, staff have access to a packaged shroud kit to assist them in preliminary preparation of the deceased for transport to a funeral home for embalming. The shroud kit is neatly packaged and about the size of folded bed sheets that one would find in a department store.

The shroud kit includes a chin strap for keeping the deceased's mouth closed. An under pad is also included to catch voided waste as the deceased automatically voids upon passing. Toe straps, identification tags and ties are included which allow for the entry and transport of various information relative to the deceased.

Finally; the shroud kit also includes a sheet that is placed over substantially the entire body until embalmment.

As time elapses prior to embalmment, the body dehydrates causing cartilage breakdown and a decreased elasticity of the skin. The weight of the sheet causes deformations including flattening of the skin and translations of the nose during dehydration base member which fits under the deceased's head.

There is also provided a face protector that prevents a sheet from coming into contact with a deceased's face. The face protector includes at least one upright support member. A top protective member is supported by the upright support member. The top protective member is superpositioned above but not in contact with the deceased's face. The sheet lies over the top of the top protective member so that the sheet does not come into contact with the deceased's face.

The face protector can also include a base member extending from a bottom of the upright support member. Further, the face protector can include at least one swing away column and at least one foldable support, wherein the foldable support includes a notched portion that cooperates with the swing away column to keep the swing away column in an open position.

In another embodiment the upright support member includes at least one arcuate rigid member, such that the top protective member includes an apex of the arcuate rigid member.

As noted the face protector may be conveniently provided in a shroud kit or packaged separately.

### BRIEF DESCRIPTION OF THE DRAWINGS

The above and other objects of the present invention will be better understood by reading the following detailed description of the preferred embodiments of the invention, when considered in connection with the accompanying drawings, in which:

FIG. 1 is a perspective view of a face protector in accordance with a preferred embodiment of the present invention;

FIG. 2 is a front view of a starting block that is used to manufacture the face protector of FIG. 1;

FIG. 3 is a front view showing the cuts, notches and slits that are made to the starting block of FIG. 2 to create the face protector of FIG. 1;

FIG. 4 is a perspective view of a face protector in accordance with an alternate embodiment of the present invention;

FIG. 5 is a bottom view of a face protector in accordance with yet another alternative embodiment of the present invention in a storage position;

FIG. 6 is a perspective to view of the face protector of FIG. 5 in use;

FIG. 7 is a perspective view of a face protector in accordance with a further embodiment of the present invention;

FIG. 8 is a side view of the starting blocks needed to assemble a face protector in accordance with yet another embodiment of the present invention; and

FIG. 9 is a perspective view of the face protector of FIG. 8 in an assembled fashion.

### DETAILED DESCRIPTION OF THE PRESENT INVENTION

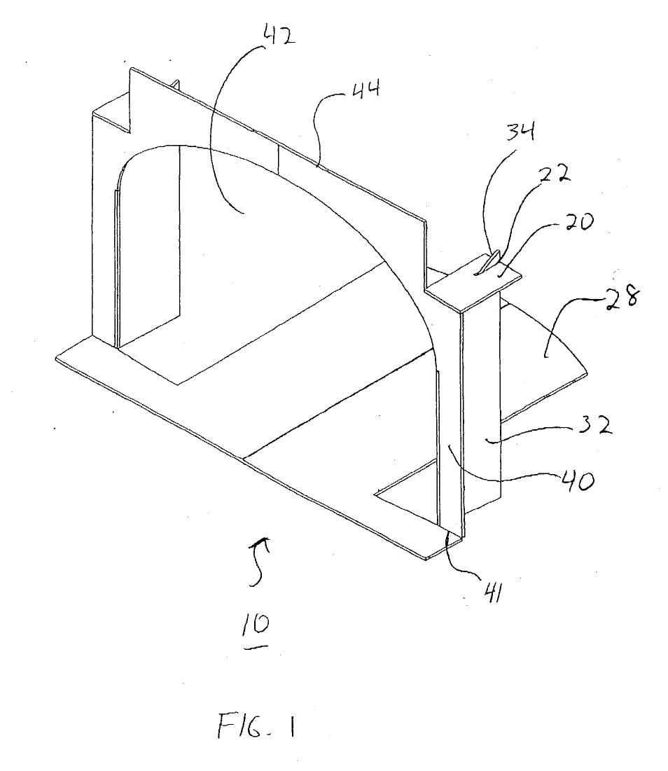

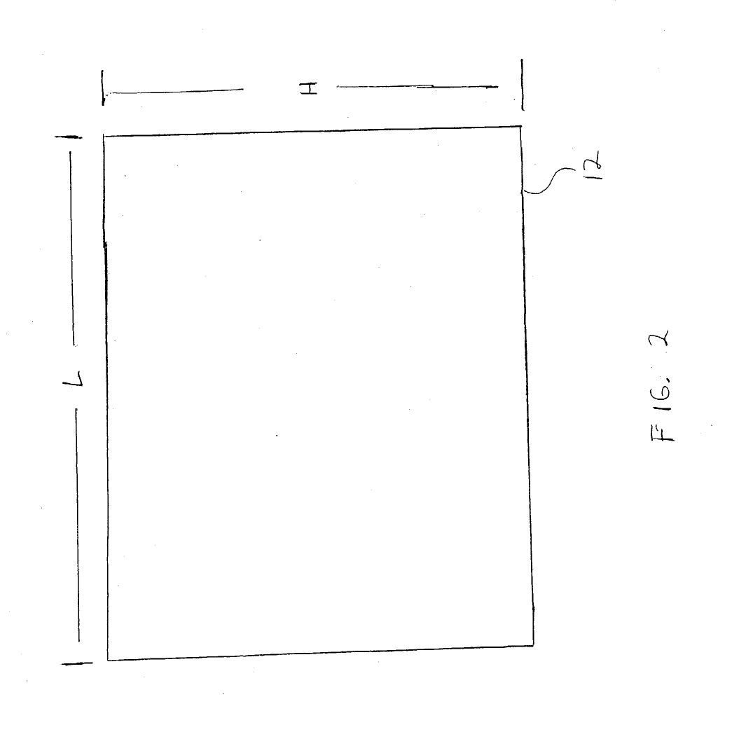

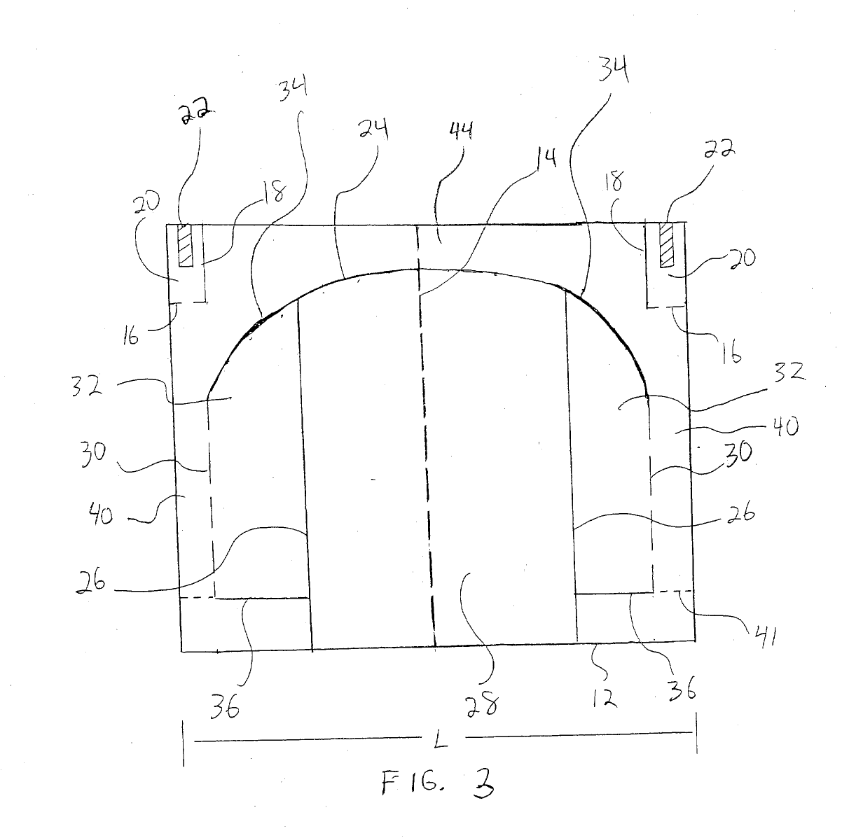

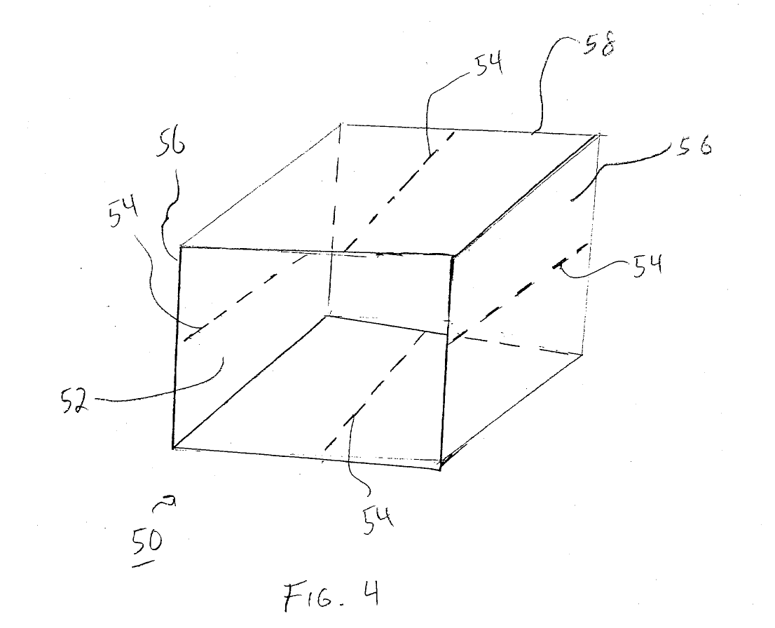

Referring now to FIG. 1, there is shown a preferred embodiment of a face protector 10 in accordance with the present invention. The invention should not be limited by the preferred embodiment because it will become apparent to one skilled in the art that many other suitable embodiments can achieve the desired results. Therefore, this invention should only be limited by the claims that are appended to this description.

Preferably, the face protector 10 is manufactured from a corrugated cardboard but piece 12 from the shroud kit, the rectangular piece 12 is unfolded.

The base 28 is pushed down so that it becomes perpendicular to the columns 32 and a pair of side walls 40. An opening 42 is formed by the space voided by the base 28.

The swing away columns 32 are then rotated so that they become perpendicular to the side walls 40 in the vertical plane. Next, the foldable supports 20 are folded downward until the notch 22 cooperates with the shoulder 34 of the swing away column 32. Thus, the swing away column 32 is now secured to its upright perpendicular position with respect to the side walls 40.

An overarch 44 extends from one side wall 40 to the other. The swing away columns 32 cooperate with the side walls 40 to prevent the overarch 44 from falling frontward, backward or sideways.

The unfolded face protector 10 is now fitted about the deceased's head, while the overarch 44 becomes positioned over the deceased's face (not shown).

Now the sheet from the shroud kit can be placed over the deceased. The overarch 44 prevents the sheet from coming into contact with the deceased's face, thereby preventing unwanted deformations as the deceased dehydrates.

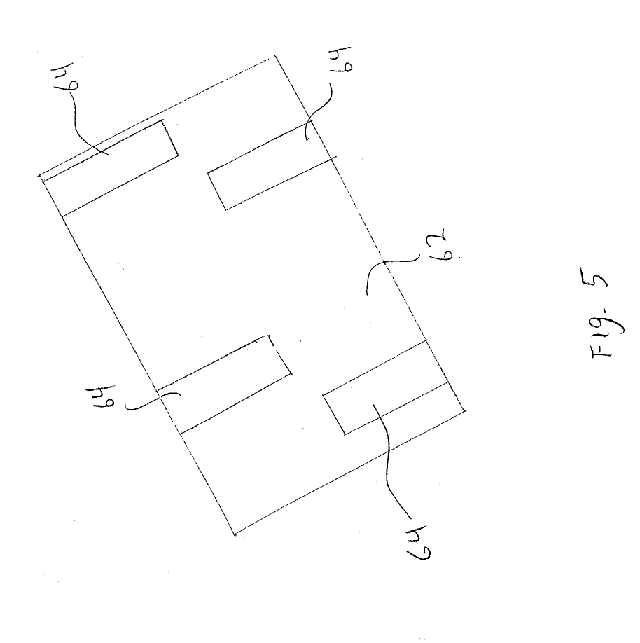

In still another embodiment, depicted in FIG. 4, a face protector 50 is formed from cardboard such that a rectangular opening 52 slides over the deceased's head. This rectangular cardboard structure 52 can be provided with enough folds 54 to allow it to conveniently fit inside of the shroud kit. A pair of opposing side walls 56 and a top 58 prevent the sheet from coming into contact with the deceased's face. Optionally, corner folds or toes provide stability against movement and collapse.

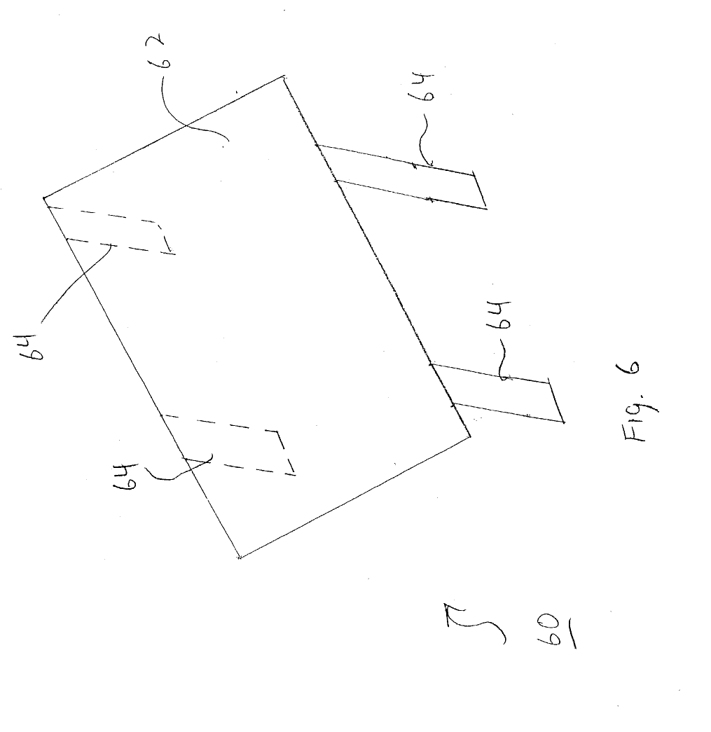

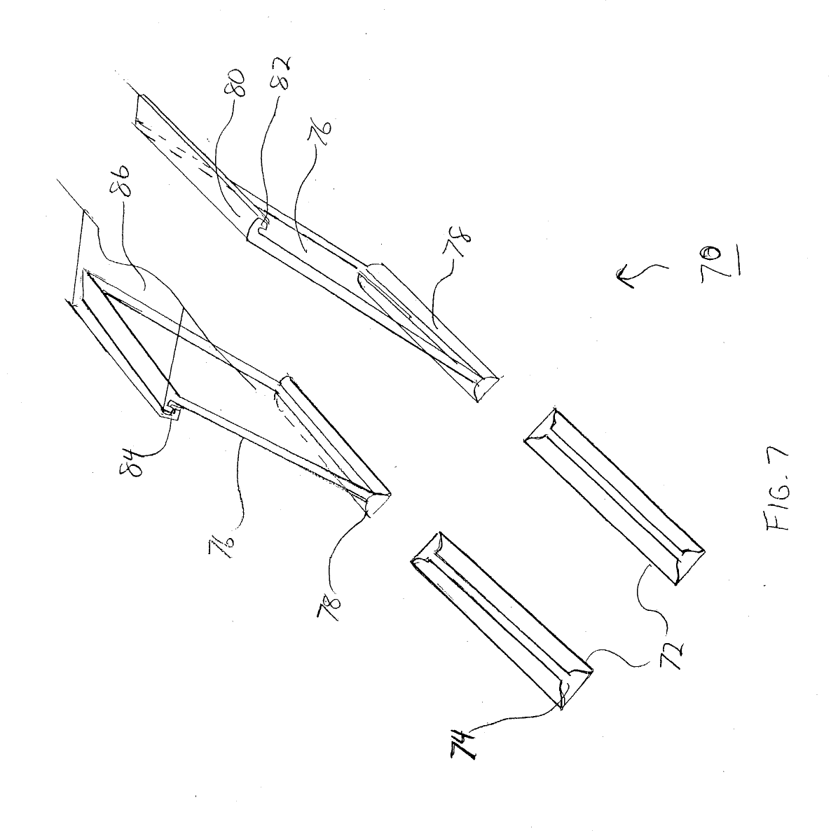

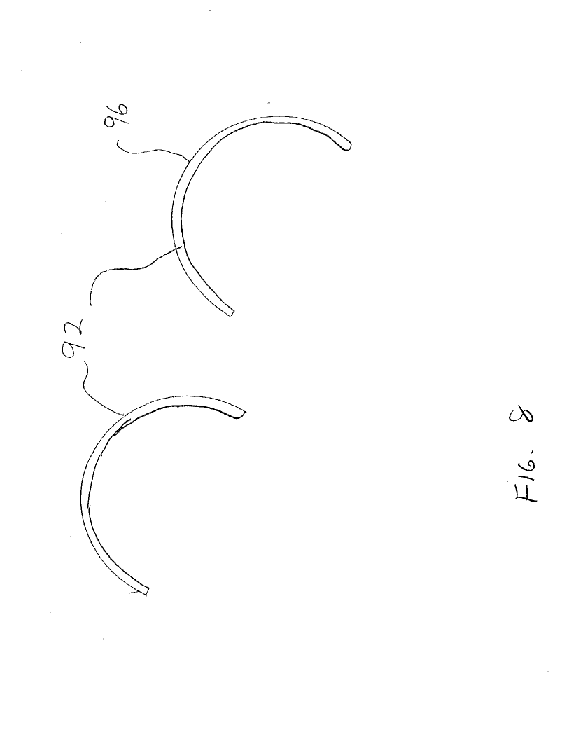

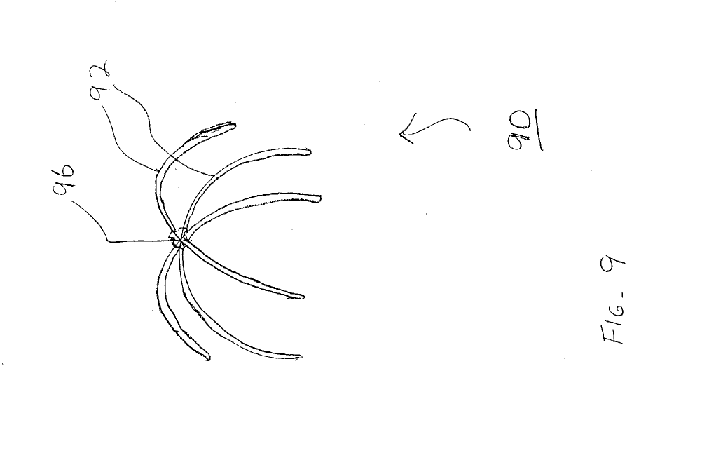

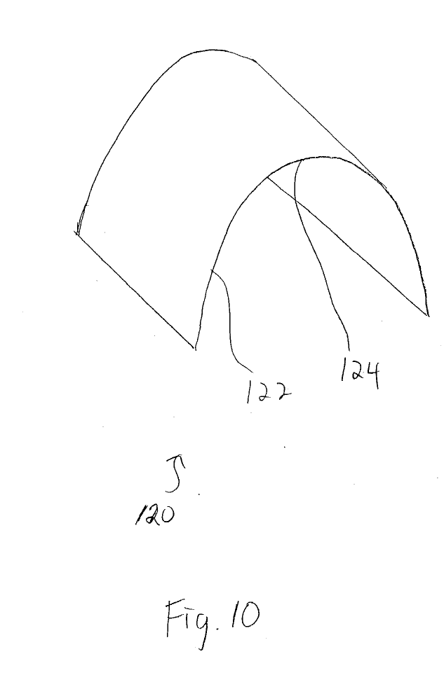

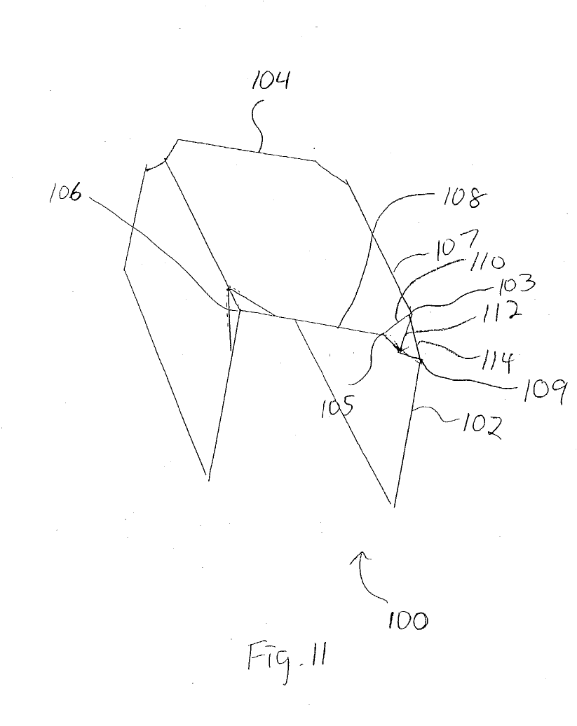

Referring now to FIGS. 5 and 6, there is provided yet another embodiment of the face protector 60 of the present invention. Looking at FIG. 5, a pliable material, having ability to face protectors 120 to be conveniently stored on top of each other.

Looking at FIG. 11, there is still yet another face protector 100 in accordance with the present invention. A pair of opposing support members 102 are positioned on each side of the deceased's face. A top member 104 intersects and is supported by the opposing support member 102.

To increase stability of the face protector 100 a number of corner toes 106 are fabricated by strategically placing partial slits or folds along the edge where the top member 104 meets the support member 102.

A first partial slit or fold 110 is disposed from part way 103 along the top 107 of the support members 102 to part way 105 along edge 108 of the top member 104.

A second partial slit or fold 112 is disposed from part way 103 along the top 107 of the support member 102 to the intersection point of intersection between the edge 108 of the top member 104 and the support member 102.

A third partial slit or fold 114 is disposed from part way 103 along the top of the support member 102 to part way down an edge 109 of the support member 104.

Each corner of the face protector 100 is similarly fabricated so that each of the toes 106 are depressed to provide increased stability.

Various changes and modifications, other than those described above in the preferred embodiment of the invention described herein will be apparent to those skilled in the art. While the invention has been described with respect to certain preferred embodiments and exemplifications, it is not intended to limit the scope of the invention thereby, but solely by the claims appended hereto.

What is claimed is:

1. A method for preventing undesired deformations to a deceased's face, wherein said undesired deformations are caused by the weight of a sheet placed over the deceased's face between the time of death and the time of embalmment, said method comprising:
fitting a face protector about the deceased's head, wherein said face protector includes a portion thereof that lies over at least a portion of but does not contact the deceased's face; and
placing the sheet over the deceased, wherein said sheet lies over the face protector but does not contact the deceased's face.

2. The method of claim 1, further including the step of transferring the deceased for embalmment.

3. The method of claim 1, further including the step of removing the face protector from a shroud kit.

4. The method of claim 1, further including the step of assembling the face protector.

5. The method of claim 3, further including the step of assembling the fact protector.

6. A face protector that prevents a sheet from contacting a deceased's face, said face protector comprising:
supporting means that extends above the deceased's face; and
at least one top protective member extending from said supporting means, said at least one top protective member being above but not in contact with the deceased's face, wherein the sheet lies over the top of the at least one top protective member so that the sheet does not contact the deceased's face.

7. The face protector of claim 6, further including a base member extending from a bottom of said supporting means.

8. The face protector of claim 7, further including at least one swing away column and at least one foldable support, wherein said foldable support includes a notched portion that cooperates with said at least one swing away column to keep said swing away column in an open position.

9. The face protector of claim 6, wherein said supporting means includes at least one arcuate rigid member, and wherein said at least one top protective member includes an apex of said at least one arcuate rigid member.

10. The face protector of claim 6, wherein said supporting means and said at least one top member form a trough shaped face protector.

11. A shroud kit for preparing a deceased for embalmment, said shroud kit comprising:
at least one waste receiver for receiving human waste voided by said deceased;
at least one identification tag for presenting indicia relative to said deceased;
a chin strap for keeping said deceased's mouth closed;
a sheet for covering said deceased between the time of death and the time for embalmment; and
at least one face protector, said face protector including supporting means; and
at least one top protective member extending from said supporting means, said
at least one top protective member being above but not in contact with the deceased's face, wherein the sheet lies over the top of the at least one top protective member so that the sheet does not contact the deceased's face.

12. The shroud kit of claim 11, wherein said face protector further includes a base member extending from a bottom of said supporting means.

13. The shroud kit of claim 12, wherein said face protector further includes at least one swing away column and at least one foldable support, wherein said foldable support includes a notched portion that cooperates with said at least one swing away column to keep said swing away column in an open position.

14. The shroud kit of claim 11, wherein said supporting means includes at least one arcuate rigid member, and wherein said at least one top protective member includes an apex of said at least one arcuate rigid member.
